(19) United States
(12) Patent Application Publication
(10) Pub. No.: US 2004/0099090 A1
(43) Pub. Date: May 27, 2004

(54) Lever type motor switching apparatus

(76) Inventors: Hsueh-Chou Hsu, Kaohusing (TW); Chi-Chien Lin, Hsinchu Hsien (TW)

Correspondence Address: BIRCH STEWART KOLASCH & BIRCH, PO BOX 747, FALLS CHURCH, VA, 22040-0747, US

(21) Appl. No.: 10/300,887

(22) Filed: Nov. 21, 2002

(51) Int. Cl. F16H 3/34

(52) U.S. Cl. 74/665 GA

(57) ABSTRACT

A lever type motor switching apparatus for switching motor output power supplies at least two power receiving devices. It includes a lever, which has one end pivotally engaged with the power output shaft of the motor and another end engaged with a solenoid valve. The actuation of the solenoid valve enables a switch gear located on the lever to selectively couple with a driven gear to deliver output power to the power receiving device engaged with the driven gear.

### FIELD OF THE INVENTION

The invention relates to a motor switching apparatus adopted for use in equipment that requires multiple motor driving, such as multi-function peripherals (MFPs), and particularly to a motor switching apparatus that employs a lever to switch power.

### BACKGROUND OF THE INVENTION

Nowadays office machines such as copiers, printers, facsimile machines and scanners are indispensable information equipment in the office environment. All business and administrative tasks are closely tied to these machines. Each office machine occupies a site. Adding it all together, they take a lot of space and become a great burden to the work environment that has spatial constraints. In addition, each office machine has different functions. Utilization frequency of these single function office machines is also different. Some office machines are not frequently used. But in order to meet business requirements, they still have to be procured and installed.

In order to remedy the problems set forth above, Multi-Function Peripherals (MFPs) have been developed and introduced. These MFPs integrate the functions of copying, printing, facsimile and scanning. Users can process a wide range of office tasks by procuring only one MFP. As a result, a large amount of space and cost is saved. Moreover, the MFP often provides a simple operation interface and becomes an All-in-one device.

A conventional MFP generally has a scanner device located on the upper side to process scanning operations. Coupled with the setting of the microprocessor and communication lines, it also can perform facsimile functions after the scanning operation is done. The machine further has a printing device located therein. There is a paper-feeding device located on one side of the machine. With the printing device and the paper-feeding device coupled together, printing operations may be performed. Thus the motion mechanism of the MFP at least includes devices for scanning, printing and paper feeding. The scanner device includes a CCD or CIS to be moved reciprocally, a transmission belt engaged with the CCD or CIS, and a driving motor coupled with the transmission belt to provide rotation power. The printing device includes a carrier that holds the ink cartridge and moves reciprocally, a transmission belt engaged with the carrier, and a driving motor coupled with the transmission belt to provide rotation power. The paper-feeding device includes a rotary paper-feeding barrel, a transmission gear set engaging with a paper feeding axle, and a driving motor engaged with the transmission gear set to provide rotation power.

In the aforesaid MFP, the devices and the driving motors are coupled in a one-on-one fashion. The rotation power required by one device is provided by one driving motor. Such a design merely puts one scanner and one printer in a machine. While the electronic circuits are integrated, in terms of their respective mechanisms, each device still operates independently. Hence they are not truly integrated. The number of driving motors is not reduced, and the driving motors take a significant portion of the cost and occupy a great amount of space in the machine.

### SUMMARY OF THE INVENTION

The primary object of the invention is to resolve the problems set forth above. The invention provides a lever type motor switching apparatus for equipment that requires multiple motor output such as multi-function peripherals (MFPs), so that a single motor may be switched to a plurality of output positions to provide power to a plurality of power receiving devices.

The lever type motor switching apparatus of the invention has a lever type adjustment mechanism to switch motor output power.

According to the invention, a lever is added to couple with the motor output shaft. The lever has one end pivotally engaged with a driving gear to receive motor power and another end engaged with an actuation element. There is a switch gear located below the lever to couple with the driving gear. A plurality of driven gears for delivering output power is located around the switch gear. By controlling the movement of the actuation element, the lever may be swung about the power output shaft to enable the switching gear to selectively couple with one of the driven gears. Power may be transmitted through the driven gear to one of the power receiving devices. Thus by switching the actuation element, the motor may be switched to a plurality of power output positions to enable the power of a single motor to be transmitted to selected power receiving devices coupled with the driven gears.

The actuation element may be a solenoid valve. Through magnetization of the solenoid valve, the lever may be moved and swung downwards to change the driven gear coupled with the switch gear to accomplish the switching of power output.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention.

FIGS. 2A and 2B are schematic views of the invention switched to the first position.

FIGS. 3A and 3B are schematic views of the invention switched to the second position.

FIGS. 4A and 4B are schematic views of the invention coupled with an automatic paper feeding mechanism of an MFP for feeding paper.

FIGS. 5A and 5B are schematic views of the invention coupled with an MFP for driving a CCD.

### DESCRIPTION OF THE PREFERRED EMBODIMENT

The lever type motor switching apparatus of the invention mainly employs a lever structure that may be swung reciprocally to switch a plurality of different positions to output motor power. Conventional motors generally can rotate in a positive and a reverse direction to provide power in two directions. However they are limited to drive only one power receiving device in the positive and reverse direction. The present invention adopts a lever design to allow motor output power to be selectively switched to different positions to couple with different power receiving devices. Each power receiving device may receive positive and reverse power.

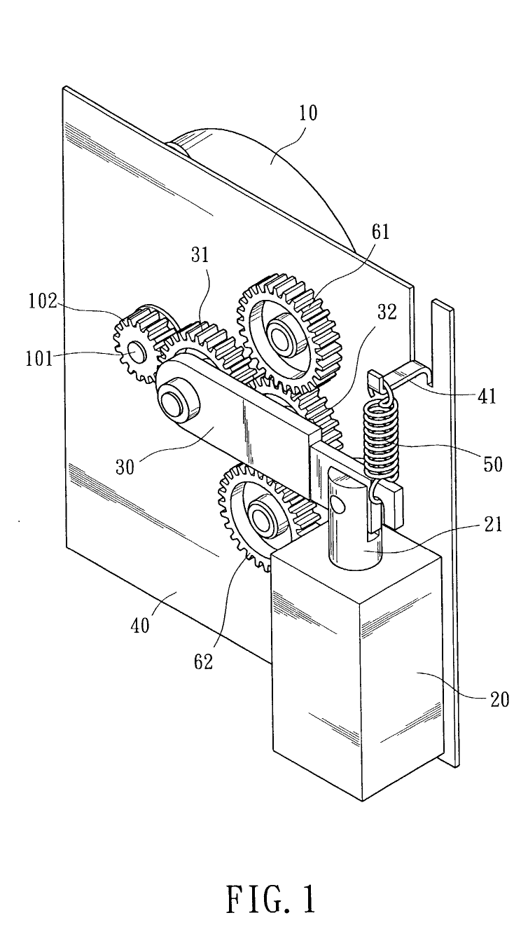

Referring to FIG. 1, the invention consists of a motor 10, a solenoid valve 20, a lever 30, a mounting board 40 and a spring 50. The motor 10 is mounted onto a back side of the mounting board 40. The motor 10 has a power output shaft 101 running through the mounting board 40 and extending to the front side of the mounting board 40 to couple with a power output gear 102 at the front end thereof to deliver the power output of the motor 10.

There is a driving gear 31 mounted onto the mounting board 40 to engage with the power output gear 102 to receive the output power of the motor 10. The lever 30 has a front end pivotally engaged with the driving gear 31 and a rear end engaged with an actuation axle 21 of the solenoid valve 20. The mounting board 40 has a hook 41 located above the solenoid valve 20. The hook 41 engages with one end of a spring 50, which has another end engaged with the rear end of the lever 30 to pull the lever 30 upwards in normal conditions. There is a switch gear 32 below the lever 30. The switch gear 32 engages with the driving gear 31 and may also selectively engage with a first driven gear 61 and a second driven gear 62 located around the switch gear 32. Through the first driven gear 61 and the second driven gear 62, power may be transmitted to different power receiving devices.

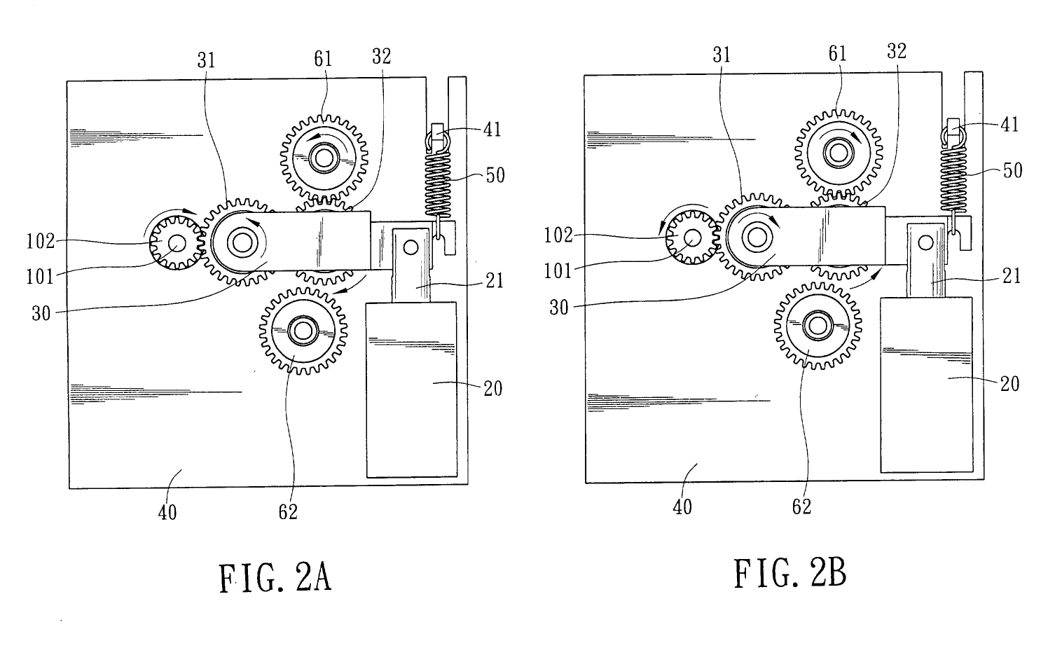

In normal conditions, the lever 30 is located at a first position as shown in FIG. 2A. The switch gear 32 engages with the first driven gear 61. When the motor 10 rotates in the positive direction, motor output power is delivered through the power output gear 102, driving gear 31 and the switch gear 32 to the first driven gear 61, which in turn provides power to a power receiving device coupled with the first driven gear 61. When the motor 10 rotates in the reverse direction (as shown in FIG. 2B), the first driven gear 61 also receives the driving power in the reverse direction.

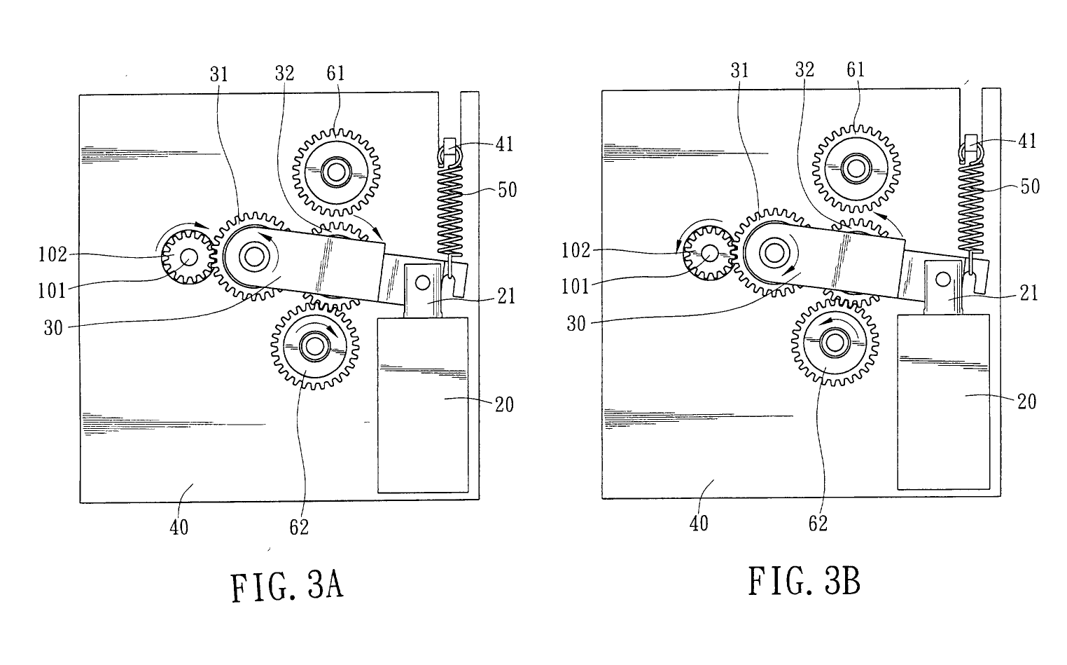

When there is a need to provide power to the second driven gear 62, the solenoid 20 is magnetized to move the actuation axle 21 downwards. The rear end of the lever 30 also is moved downwards as shown in FIG. 3A. The lever 30 is turned about the pivotal axis of the driving gear 31 and is swung downwards to make the switch gear 32 engage with the second driven gear 62 and reach a second position. Similarly, the motor 10 may rotate in the positive direction (shown in FIG. 3A) or the reverse direction (shown in FIG. 3B) to provide power for another power receiving device coupled with the second driven gear 62 in the positive or the reverse direction. When returning to the first position magnetization of the solenoid valve 20 is stopped, and the lever 30 is pulled by the spring 50 and swung to the first position.

The solenoid valve 20 mainly provides an actuating function to swing the lever 30. It may be substituted by other elements of equivalent effect. The driven gears are also not limited to two. Two or more may be deployed based on requirements.

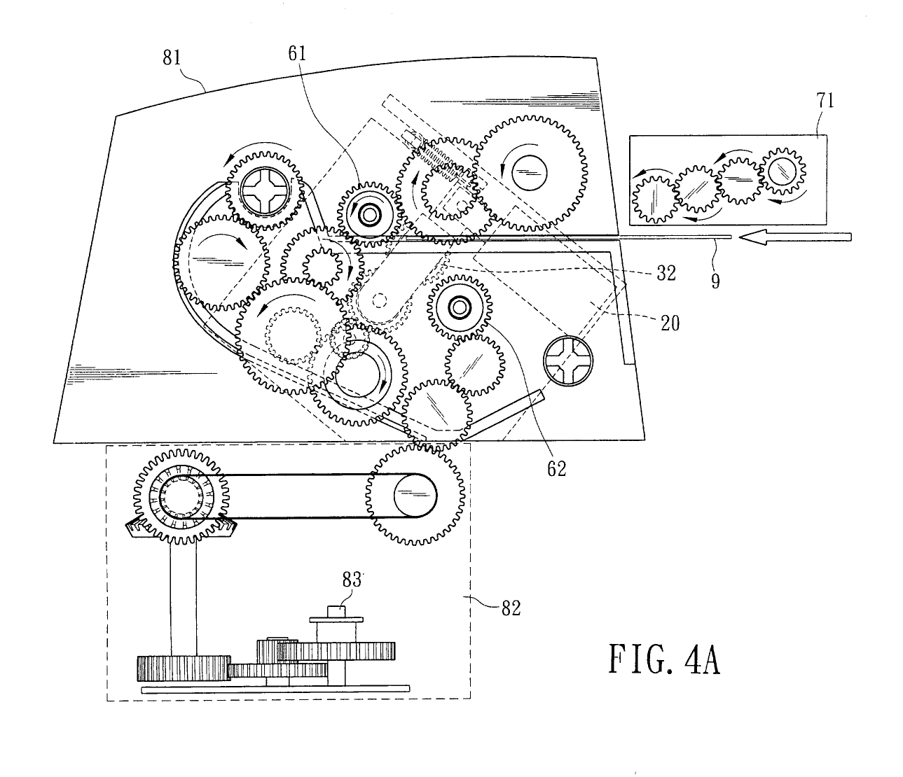

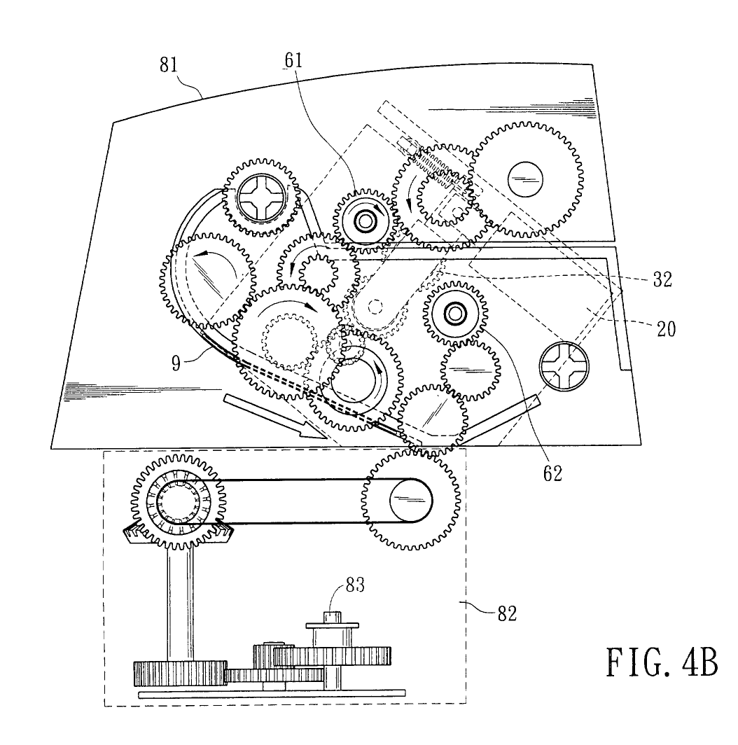

Refer to FIGS. 4A and 4B for an embodiment of the invention adopted on an MFP. The first driven gear 61 is engaged with a paper-feeding system 81 (such as an automatic paper-feeding mechanism), and the second driven gear 62 is engaged with a scanner system 82. First, the motor 10 is switched to the first position (as shown in FIG. 4A). The motor 10 rotates in the positive direction and drives a plurality of gear sets to feed paper 9 from a paper cartridge 71 into the paper feeding system 81. Then the motor 10 rotates in the reverse direction to turn and feed the paper 9 into the scanner system 82 (shown in FIG. 4B).

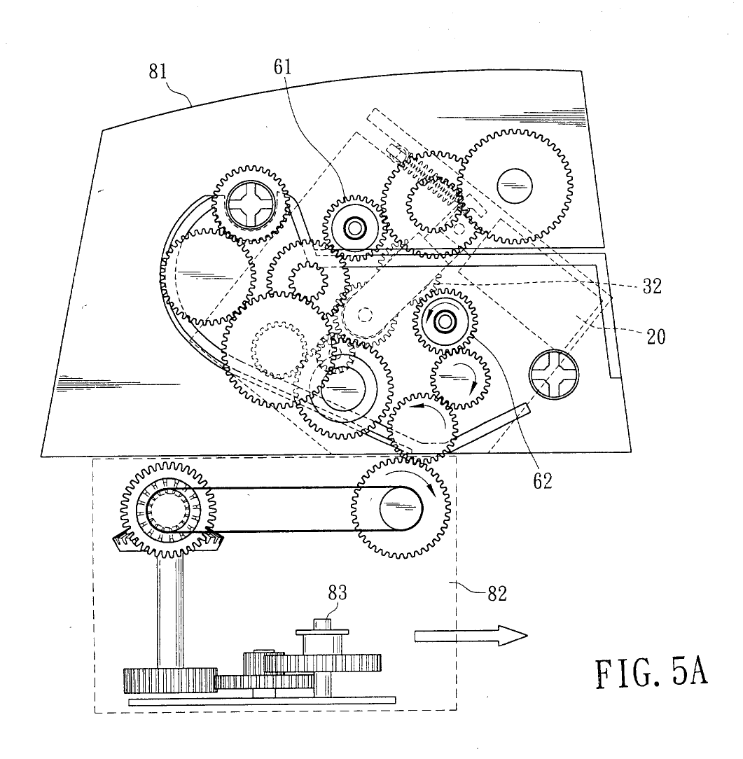

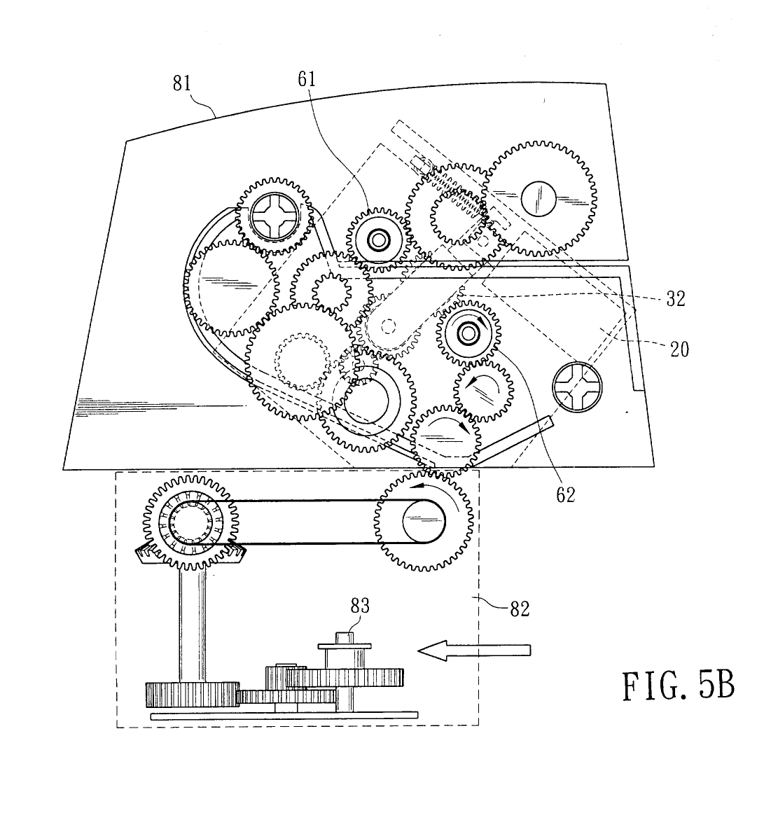

Next, the motor 10 is switched to the second position with the second driven gear 62 engaging with the scanner system 82. Through a plurality of gear sets, power is transmitted to a CCD 83. Then the motor 10 may rotate positively and reversely to drive the CCD 83 reciprocally to perform scanning operations (as shown in FIGS. 5A and 5B). Therefore the two systems that require the motor 10 (the paper feeding system and scanner system) may be integrated and served by one single motor 10. Of course, applications of the invention are not limited to MFPs or scanner and paper feeding systems. Any equipment that requires multiple motor output may be integrated through the invention.

In summary, the lever type motor switching apparatus of the invention employs a solenoid valve to connect one end of a lever. When the solenoid valve is actuated, the lever is moved and swung to enable a switch gear located thereon to selectively engage with a driven gear to deliver output power to a power receiving device. By switching the lever, utilization of a single motor may be maximized to transmit power to several devices.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A lever type motor switching apparatus coupled with a motor for switching motor power to a plurality of output positions to output, comprising:
a driving gear engaging with a power output shaft of the motor;
a lever having first end pivotally engaged with the driving gear;
an actuation element engaged with another end of the lever;
a switch gear coupled with the driving gear; and
a plurality of driven gears adjacent to the switch gear;
wherein the lever is swingable about the power output shaft resulting from movements of the actuation element such that the switch gear is selectively coupled with one of the driven gears for delivering output power through the driven gear.

2. The lever type motor switching apparatus of claim 1, wherein the actuation element is a solenoid valve.

3. The lever type motor switching apparatus of claim 2, wherein the solenoid valve has an output end connecting to a second end of the lever for swinging the lever reciprocally.

4. The lever type motor switching apparatus of claim 3, wherein the second end of the lever couples with a spring for moving the lever to a selected position when the solenoid valve is not actuated.

5. The lever type motor switching apparatus of claim 1, wherein the driving gear couples with a power output gear mounted onto the power output shaft of the motor.

6. The lever type motor switching apparatus of claim 1, wherein the driven gears couple respectively with a power receiving device so that the power receiving device receives positive or reverse power from the motor which rotates in the positive or the reverse direction.
